(19) United States
(12) Patent Application Publication
(10) Pub. No.: US 2018/0236383 A1
(43) Pub. Date: Aug. 23, 2018

(54) FILTER AIDS FOR BIODIESEL AND EDIBLE OIL FILTRATION AND METHODS AND USES OF THE FILTERING AIDS

(71) Applicant: Imerys Filtration Minerals, Inc., San Jose, CA (US)

(72) Inventors: Scot BIRMINGHAM, San Francisco, CA (US); Robert FLEMING, San Jose, CA (US); Giorgio LA MOTTA, San Jose, CA (US)

(21) Appl. No.: 15/553,260

(22) PCT Filed: Feb. 22, 2016
(86) PCT No.: PCT/US16/18868

§ 371 Date: Aug. 24, 2017

Related U.S. Application Data
(60) Provisional application No. 62/121,311, filed on Feb. 26, 2015.

(51) Int. Cl. B01D 37/02; B01D 15/08; A23D 9/02; B01J 20/10; B01J 20/14; B01J 20/28; B01J 20/30; B01J 20/32; C11B 3/10; C11B 3/00; C10L 1/02

(52) U.S. Cl. CPC B01D 37/02; C10L 2270/026; A23D 9/02; B01J 20/103; B01J 20/14; B01J 20/28011; B01J 20/3085; B01J 20/3204; B01J 20/3234; C11B 3/10; C11B 3/008; C10L 1/026; C10L 2200/0476; C10L 2290/542; C10L 2290/547; B01D 15/08

(57) ABSTRACT

A filter aid composition may include an acid-treated composite silicate. The composite silicate comprises a silicate substrate and a precipitated silica. A method for making a filter aid composition may include providing a silicate substrate, precipitating a silica onto the silicate substrate to form a composite silicate, and treating the composite silicate with an acid to form an acid-treated composite silicate. A method for filtering a non-aqueous liquid may include providing a non-aqueous liquid for filtering and filtering the non-aqueous liquid through an acid-treated composite silicate. The composite silicate may include a silicate substrate and a precipitated silica. A filter aid may include an acid-treated composite diatomite. The acid-treated composite diatomite may include a diatomite substrate and a precipitated silica gel coating. The precipitated silica may be a precipitated ilica gel.

### CLAIM OF PRIORITY

This PCT International Application claims the benefit of priority of U.S. Provisional Application No. 62/121,311, filed Feb. 26, 2015, the subject matter of which is incorporated herein by reference in its entirety.

### FIELD OF THE DESCRIPTION

This disclosure relates to filter aid compositions, methods for making filter aid compositions, and methods for using filter aid compositions. More particularly, this disclosure relates to filter aids that may be used in filtration applications, including filtering non-aqueous liquids, such as biodiesel and edible oils.

### BACKGROUND

Identifying and using economically viable renewable energy has been a policy goal of governments around the world. One source of renewable fuel that has been promoted and developed is biodiesel. Biodiesel is attractive because it has similar properties to petroleum-based diesel fuel Biodiesel may be a desirable energy alternative to wind-, solar-, and ethanol-derived energy because the energy content to capital requirement is close to a break-even point, depending upon the price of petroleum-derived energy.

Biodiesel is a form of purified alkyl esters of fatty acids generally referred to as fatty acid alkyl esters (FAAEs). Production of these FAAEs is achieved by the transesterification of animal or vegetable fats or oils or the esterification of fatty acids, including free fatty acids (FFAs) found in degraded fat or oil. The process involves reacting triacylglycerol with an alcohol, typically methanol, in the presence of a catalyst (such as sodium or potassium hydroxide or methoxide), resulting in a reaction referred to as transesterification. Alternatively, fatty acids, including those found in degraded fat or oil containing high levels of FFAs, typically referred to as “yellow grease,” “brown grease,” or “trap grease,” are reacted with an alcohol, typically methanol, in the presence of an acid, resulting in a reaction referred to as esterification. When using degraded fat or oil as a raw material, esterification is performed prior to transesterification in order to promote conversion of fatty acids into FAAEs. Unreacted methanol from both processes is then removed by flash evaporation so that it can be reused for subsequent esterification and/or transesterification reaction(s).

Biodiesel can also be derived from triacylglycerides (also called triglycerides), which may be obtained from both plant sources and animal fat sources, such as, for example, soybean oil, rapeseed oil, palm oil, coconut oil, corn oil, cottonseed oil, mustard oil, used cooking oils, float grease from wastewatertreatment plants, animal fats, such as beef tallow and pork lard, soapstock, crude oils, “yellow grease” (i.e., animal or vegetable oils and fats that have been used or generated as a result of the preparation of food by a restaurant or other food establishment that prepares or cooks food for human consumption with a free fatty acid content of less than 15%), and “white grease,” which is rendered fat derived primarily from pork, and/or other animal fats having a maximum free fatty acid content of 4%.

However, simply performing the esterification and/or transesterification of fatty acids is not enough to produce a usable biodiesel fuel. FAAEs contain impurities that can crystallize, foul engines, and cause numerous problems for the user. As a result, regulations have been developed to address the quality assurance needs of the consumer. Strict standards for commercial biodiesel have been developed by the governments of most countries, including the U.S. Government in ASTM International's ASTM D6751 and the European Union by the European Committee for Standardization in EN 14214.

As a result of the above-described transesterification reaction, two products are produced: fatty acid alkyl esters (FAAEs) (typically Fatty Acid Methyl Esters) and glycerin. The glycerin portion is separated from the FAAE portion, either by centrifugation or gravity settling, and the resulting FAAEs are often referred to as “crude biodiesel.” The crude biodiesel portion consists of FAAEs containing impurities that must be removed before it can be commercially marketed as biodiesel. These impurities include, but are not limited to, alcohol, glycerin, soaps, residual catalysts, metals, free fatty acids, sterol glycosides as well as other impurities that reduce the stability of biodiesel. Therefore, at this point in the process, the FAAEs cannot be commercially marketed as biodiesel until the proper specifications (e.g. ASTM D6751, EN 14214, and the like) are achieved.

Alkaline catalysts present to speed the reaction of biodiesel formation; however, also form a soap during the reaction. For example, a sodium soap is formed when a sodium hydroxide catalyst is employed. The soap must be removed from the biodiesel before it can be used as a fuel, because it would leave a residual ash if any soap were present. A “water wash” is typically used to remove the soap, For example, water is sprayed at low velocity on top of the biodiesel because the soaps and excess alcohol and catalyst may become soluble in the water phase. Soap, however, also commonly causes emulsification of the water and methyl ester. When a large amount of soap is present, the water-washing causes emulsion problems, because the fatty acid esters, such as fatty acid methyl esters, will not separate from the water. In addition, water-washing does not eliminate effectively some of the other contaminants, such as sulfur, phosphorus, and any remaining FFAs.

Biodiesel filtration may occur through hydrogel-based filter aids. However, hydrogels may be expensive to produce and may require large amounts of hydrogel per liter of biodiesel when filtering. Hydrogels may also have unacceptably slow filtration rates. In addition, hydrogels may often include 40 to 60% water, and thus, undesirably add water to the biodiesel along with the silica gel. Biodiesel filtration may also occur through the use of silicate absorbents such as magnesium silicate. However, both magnesium silicate and hydrogels often exhibit problems when used alone as a filter aid, and in many cases diatomaceous earth may be added to assist with the filtration. Thus, it may be desirable to provide filter aids that simplify the filtration process, for example, by using an absorbent, which is also an effective filter aid, thus reducing or removing the need to use additional additives.

Thus, it may be desirable to provide a filter aid composition with improved ability to remove soap and other impurities. It may also be desirable to provide a filter aid having adsorption properties with improved filtration rates. It may also be desirable to provide a method of making a filter aid composition and of using a filter aid composition to improve the filtration of FAAEs, such as biodiesel, or oils, such as edible oils.

### SUMMARY

In accordance with a first aspect, a filter aid composition may include an acid-treated composite silicate. The composite silicate comprises a silicate substrate and a precipitated silica.

According to another aspect, a method for making a filter aid composition may include providing a silicate substrate, precipitating a silica onto the silicate substrate to form a composite silicate, and treating the composite silicate with an acid to form an acid-treated composite silicate.

According to a further aspect, a method for filtering a non-aqueous liquid may include providing a non-aqueous liquid for filtering and filtering the non-aqueous liquid through an acid-treated composite silicate. The composite silicate may include a silicate substrate and a precipitated silica.

According to still another aspect, a filter aid may include an acid-treated composite diatomite. The acid-treated composite diatomite may include a diatomite substrate and a precipitated silica gel coating.

According to a further aspect, the precipitated silica may be a precipitated silica get The precipitated silica may be an amorphous silica. According to another aspect, the precipitated silica may form a silica gel coating on the silicate substrate.

According to a further aspect, a method is provided for filtering a non-aqueous liquid. The method may include providing a non-aqueous liquid for filtering; admixing a composite silicate and an acid with the non-aqueous liquid as a body feed; and filtering the non-aqueous liquid through a filter structure to separate the composite silicate from the non-aqueous liquid. The composite silicate may include a silicate substrate and a precipitated silica. In one aspect, prior to filtering the non-aqueous liquid, the filter structure may be pre-coated with the composite silicate.

It is to be understood that both the foregoing general description and the following detailed description are exemplary and explanatory only and are not restrictive of the invention, as claimed,

### BRIEF DESCRIPTION OF THE DRAWINGS

FIG. 1 shows an exemplary process flow for filtering fatty acid alkyl esters.

FIG. 2 is a chart showing filtration rate versus soap removal for exemplary filter aid compositions.

### DESCRIPTION OF EXEMPLARY EMBODIMENTS

According to some embodiments, a filter aid composition may include an acid-treated composite silicate. The composite silicate comprises a silicate substrate and a precipitated silica

According to some embodiments, a method for making a filter aid composition may include providing a silicate substrate, precipitating a silica onto the silicate substrate to form a composite silicate, and treating the composite silicate with an acid to form an acid-treated composite silicate.

According to some embodiments, the acid may be a mild acid. The mild acid may include, for example, citric acid, acetic acid, oxalic acid, malic acid, tartaric acid, ascorbic acid, or mixtures thereof.

According to some embodiments, treating the composite silicate with acid may include treating the silicate with greater than or equal to about 5% by weight of acid relative to the total weight of the composite silicate and the acid combined (i.e., 5% by weight of anhydrous acid relative to the total weight including the moisture of the filter aid composite), such as, for example, greater than or equal to about 7% by weight, greater than or equal to about 10% by weight, greater than or equal to about 12% by weight, or greater than or equal to about 14% by weight of acid relative to the total weight of the composite silicate and the acid combined.

According to some embodiments, treating the composite silicate with acid may include treating the composite silicate with an amount of acid in a range from about 5% to about 20% by weight of acid relative to the total weight of the composite silicate and the acid combined, such as, for example, from about 7% to about 20% by weight, from about 7% to about 15% by weight, from about 10% to about 15% by weight, from about 10% to about 13% by weight, or from about 12% to about 15% by weight of acid relative to the total weight of the composite silicate and the acid combined.

According to some embodiments, treating the silicate may include spraying the silicate with a mixture of acid and water. The method may also include mixing the composite silicate during or after the acid treatment.

According to some embodiments, treating the composite silicate with acid may include treating the composite silicate with greater than or equal to about 5% by weight of acid relative to the total weight of the composite silicate, water, and acid combined, such as, for example, greater than or equal to about 7% by weight, greater than or equal to about 10% by weight, greater than or equal to about 12% by weight, or greater than or equal to about 14% by weight of acid relative to the total weight of the composite silicate, water, and acid combined.

According to some embodiments, treating the composite silicate with acid may include treating the composite silicate with an amount of acid in a range from about 5% to about 20% by weight of acid relative to the total weight of the composite silicate, water, and acid combined, such as, for example, from about 7% to about 20% by weight, from about 7% to about 15% by weight, from about 10% to about 15% by weight, from about 10% to about 13% by weight, or from about 12% to about 15% by weight of acid relative to the total weight of the composite silicate, water, and acid combined.

According to some embodiments, treating the composite silicate may include treating the composite silicate with greater than or equal to about 1% by weight of water relative to the total weight of the composite silicate, water, and acid combined, such as, for example, greater than or equal to about 2% by weight, greater than or equal to about 3% by weight, greater than or equal to about 4% by weight, greater than or equal to about 5% by weight, greater than or equal to about 6% by weight, greater than or equal to about 7% by weight, greater than or equal to about 8% by weight, greater than or equal to about 10% by weight, greater than or equal to about 12% by weight, greater than or equal to about 15% by weight, greater than or equal to about 17% by weight, greater than or equal to about 20% by weight, greater than or equal to about 22% by weight, or greater than or equal to about 25% by weight of water relative to the total weight of the composite silicate, water, and acid combined.

According to some embodiments, treating the composite silicate may include treating the composite silicate with an amount of water in a range from about 5% to about 30% by weight of water relative to the total weight of the composite silicate, water, and acid combined, such as, for example, from about 7% to about 30% by weight, from about 10% to about 25% by weight, from about 15% to about 25% by weight, from about 10% to about 20% by weight, from about 10% to about 15% by weight, from about 15% to about 20%, or from about 20% to about 25% by weight of water relative to the total weight of the composite silicate, water, and acid combined,

According to some embodiments, when treating the composite silicate with acid or water and acid, the pH of the treatment may be in a range from about 1 to about 5, such as, for example, from about 2 to about 5, from about 1 to about 2, from about 2 to about 3, from about 3 to about 4, or from about 4 to about 5.

According some embodiments, a method for filtering a non-aqueous liquid may include providing a non-aqueous liquid for filtering and filtering the non-aqueous liquid through an acid-treated composite silicate. The composite silicate may include a silicate substrate and a precipitated silica.

According to some embodiments, the method may include, prior to filtering the non-aqueous liquid, pre-coating a filter structure with the composite silicate. According to some embodiments, providing the non-aqueous liquid may include adding the acid-treated composite silicate as a body feed in the non-aqueous liquid.

According to some embodiments, the silicate substrate may include biogenic silica. According to some embodiments, the silicate substrate may be chosen from the group consisting of diatomite, perlite, pumice, volcanic ash, calcined kaolin, smectite, mica, talc, shirasu, obsidian, pitchstone, rice hull ash, and combinations thereof. According to some embodiments, the silicate may include diatomite.

According to some embodiments, the precipitated silica may be a precipitated silica gel. According to some embodiments, the precipitated silica may be an amorphous silica. The precipitated silica may for a silica coating, such as a silica gel coating, on the silicate substrate.

According to some embodiments, the amount of precipitated silica or precipitated-silica coating may be in a range from about 5% to about 80% by weight of the composite silicate, such as, for example from about 10% to about 50%, from about 10% to about 30%, or from about 20% to about 50% by weight of the composite silicate.

According to some embodiments, the acid-treated composite silicate may have a median particle size (d₅₀) in a range from 5 to 50 microns, such as, for example, from 5 to 40 microns, from 10 to 40 microns, from 10 to 30 microns, or from 15 to 25 microns. According to some embodiments, the acid-treated composite silicate may have a (d₁₀) in a range from 2 to 20 microns, such as, for example, from 3 to 15 microns, from 4 to 12 microns, or from 5 to 10 microns. According to some embodiments, the acid-treated composite silicate may have a (d₉₀) in a range from 50 to 150 microns, such as, for example, from 60 to 140 microns, from 70 to 120 microns, or from 80 to 110 microns.

According to some embodiments, the acid-treated composite silicate may have a permeability in a range from about 50 to about 5000 millidarcies (“md”). For example, the acid-treated composite silicate may have a permeability in a range from about from about 50 to about 1000 md, from about 50 to about 500 md, from about 50 to about 300 md, from about 50 to about 200 md, from about 50 to about 100 md, from about 100 to about 400 md, from about 100 to about 300 md, from about 100 to about 200 md, or from about 200 to about 300 md.

According to some embodiments, the acid-treated composite silicate may have a BET surface area in a range from about 5 to about 250 m²/g. For example, the acid-treated composite silicate may have a BET surface area in a range from about 5 to about 200 m²/g, from about 50 to about 250 m²/g, from about 100 to about 200 m²/g, from about 150 to about 250 m²/g, from about 10 to about 150 m²/g, from about 30 to about 150 m²/g, from about 30 to about 100 m²/g, from about 50 to about 100 m²/g, from about 50 to about 70 m²/g, from about 60 to about 80 m²/g, or from about 70 to about 90 m²/g.

According to some embodiments, the silicate substrate may have a median pore diameter (4V/A) in a range from about 0.1 to about 0.5 microns, such as, for example, in a range from about 0.1 to 0.4 microns, from about 0.1 to about 0.3 microns, from about 0.1 to about 0.2 microns, from about 0.2 to about 0.5 microns, from about 0.2 to about 0.4 microns, from about 0.2 to about 0.3 microns, from about 0.3 to about 0.5 microns, from about 0.3 to about 0.4 microns, or from about 0.4 to about 0.5 microns.

According to some embodiments, the silicate substrate may have a median pore diameter (volume) in a range from about 0.1 to about 10 microns, such as, for example, in a range from about 0.1 to about 5 microns, from about 0.5 to about 3 microns, from about 1 to about 5 microns, about 5 to about 10 microns, from about 2 to about 8 microns, or from about 3 to about 6 microns.

According to some embodiments, the silicate substrate may have a median pore diameter (area) in a range from about 1 to about 50 nm, such as, for example, in a range from about 1 to about 20 nm, from about 1 to about 10 nm, from about 1 to about 5 nm, from about 5 to about 10 nm, or from about 3 to about 8 nm,

According to some embodiments, the precipitated silica may have a pore size less than or equal to about 20 nm as measured by nitrogen adsorption testing using, for example, an ASAP® 2460 Surface Area and Porosimetry Analyzer, available from Micromeritics Instrument Corporation (Norcross, Ga., USA). For example, the precipitated silica may have a pore size less than or equal to about 15 nm, such as, for example, less than or equal to about 10 nm, or less than or equal to about 5 nm. According to some embodiments, the precipitated silica may have a pore size in a range from about 5 nm to about 20 nm, such as, for example, from about 5 nm to about 15 nm, from about 5 nm to about 10 nm or from about 10 nm to about 15 nm.

According to some embodiments, the precipitated silica may have a pore volume in a range from about 0.1 to about 0.5 cm³/g as measured by nitrogen adsorption testing (i.e., including the weight of the substrate). For example, the precipitated silica may have a pore volume in a range from about 0.1 to about 0.3 cm³/g or from about 0.3 to about 0.5 cm³/g.

According to some embodiments, the acid-treated composite silicate may have a wet density in a range from about 5 to about 30 lbs/ft³. For example, the acid-treated composite silicate may have a wet density in a range from about 5 to about 25 lbs/ft³, from about 5 to about 20 lbs/ft³, from about 5 to about 15 lbs/ft³, from about 5 to about 10 lbs/ft³, from about 10 to about 25 lbs/ft³, from about 10 to about 20 lbs/ft³, from about 10 to about 15 lbs/ft³, from about 15 to about 30 lbs/ft³ from about 15 to about 20 lbs/ft³, or from about 20 to about 30 lbs/ft³.

In some embodiments, the acid-treated composite silicate may have a porosity in a range from about 70% to about 95%, such as, for example, in a range from about 70% to about 80%.

### Silicate Substrate

According to some embodiments, the silicate substrate may include one or more silica-based filtration materials, such as, for example, biogenic silica and natural glasses.

The term “biogenic silica,” as used herein, refers to silica produced or brought about by living organisms. One example of biogenic silica is diatomite, which is obtained from diatomaceous earth (also known as “DE” or kieselguhr). Diatomite is a sediment enriched in biogenic silica in the form of the siliceous frustules (i.e., shells or skeletons) of diatoms. Diatoms are a diverse array of microscopic, single-celled algae of the class Bacillariophyceae, which possess an ornate siliceous skeletons or frustules of varied and intricate structure including two valves which, in the living diatom, fit together much like a pill box. Diatomite may form from the remains of water-borne diatoms and, therefore, diatomite deposits may be found close to either current or former bodies of water. Those deposits are generally divided into two categories based on source: freshwater and saltwater. Freshwater diatomite is generally mined from dry lakebeds and may be characterized as having a low crystalline silica content and a high iron content. In contrast, saltwater diatomite is generally extracted from oceanic areas and may be characterized as having a high crystalline silica content and a low iron content. The morphology of the diatom frustules may vary widely among species and serves as the basis for taxonomic classification; at least 2,000 distinct species are known. The surface of each valve is punctuated by a series of openings that include the complex fine structure of the frustule and impart a design that is distinctive to individual species. The size of typical frustules may be in a range from about 0.75 microns to about 1.000 microns. In some embodiments, the size of the frustules may be in a range from about 10 microns to about 150 microns. The frustules in this size range may be sufficiently durable to retain much of their porous and intricate structure virtually intact through long periods of geologic time when preserved in conditions that maintain chemical equilibrium.

Other sources of biogenic silica include plants, animals, and microorganisms, which may provide concentrated sources of silica with unique characteristics. For example, rice hulls contain sufficient silica that they can be commercially ashed for their siliceous residue, a product commonly known as “rice hull ash.” Certain sponges are also concentrated sources of silica, the remnants of which may be found in geologic deposits as acicular spicules.

The term “natural glass,” as used herein, refers to natural glasses, which may also be referred to as volcanic glasses, that are formed by the rapid cooling of siliceous magma or lava. Several types of natural glasses are known, including, for example, perlite, pumice, pumicite, obsidian, and pitchstone. Volcanic glasses, such as perlite and pumice, occur in massive deposits and find wide commercial use. Volcanic ash, often referred to as tuff when in consolidated form, includes small particles or fragments that may be in glassy form. As used herein, the term natural glass encompasses volcanic ash.

Natural glasses may be chemically equivalent to rhyolite. Natural glasses that are chemically equivalent to trachyte, dacite, andesite, latite, and basalt are also known, but may be less common. The term obsidian is generally applied to large numbers of natural glasses that are rich in silica. Obsidian glasses may be classified into subcategories according to their silica content, with rhyolitic obsidians (containing typically about 73% SiO₂ by weight) being the most common.

Perlite is a hydrated natural glass that may contain, for example, about 72% to about 75% SiO₂ by weight, about 12% to about 14% A1₂0₃ by weight, about 0.5% to about 2% Fe₂O₃ by weight, about 3% to about 5% Na₂O by weight, about 4 to about 5% K₂O by weight, about 0.4% to about 1.5% CaO by weight, and small amounts of other metallic elements. Perlite may be distinguished from other natural glasses by a higher content (such as about 2% to about 5% by weight) of chemically-bonded water, the presence of a vitreous, pearly luster, and characteristic concentric or arcuate onion skin-like (i.e., perlitic) fractures. Perlite products may be prepared by milling and thermal expansion, and may possess unique physical properties such as high porosity, low bulk density, and chemical inertness. Perlite, as used herein, also includes expanded perlite.

Talc is magnesium silicate mineral, a mineral chlorite (magnesium aluminum silicate), or a mixture of the two. Talc may be optionally associated with other minerals, for example, dolomite and/or magnesite. Talc also includes synthetic talc, also known as talcose. In particular embodiments, the talc may be a macro or microcrystalline talc. The individual platelet size, i.e. the median diameter as measured by the Sedigraph method, of an individual talc platelet (a few thousand elementary sheets) can vary from approximately 1 μm to over 100 μm, depending on the conditions of formation of the deposit. The individual platelet size determines the lamellarity of the talc. A highly lamellar talc will have large individual platelets, whereas a microcrystalline talc will have small platelets. Although all talcs may be termed lamellar, their platelet size differs from one deposit to another. Small crystals provide a compact, dense ore, known as microcrystalline talc. Large crystals come in papery layers, known as macrocrystalline talc. Known microcrystalline talc deposits are located in Montana (Yellowstone) and in Australia (Three Springs). In a microcrystalline structure, talc elementary particles are composed of small plates compared to macrocrystalline structures, which are composed of larger plates

Pumice is a natural glass characterized by a mesoporous structure (e.g., having pores or vesicles, sometimes having pore sizes up to about 1 mm). The porous nature of pumice gives it a very low apparent density, in many cases allowing it to float on the surface of water. Most commercial pumice contains from about 60% to about 70% SiO₂ by weight. Pumice may be processed by milling and classification, and products may be used as lightweight aggregates and also as abrasives, adsorbents, and fillers. Unexpanded pumice and thermally-expanded pumice may also be used as filtration components.

### Composite Filter Aids

According to some embodiments, the filter aid composition may include a composite silicate. As used herein, the term “composite silicate” refers to a material having a silicate substrate and precipitated silica. The silicate substrate may act as a filtration component while the precipitated silica may act as an adsorbent component. The composite silicate may have different properties from either constituent silicate substrate or precipitated silica alone. According to some embodiments, the precipitated silica may include a precipitated silica coating on the silicate substrate. For example, the precipitated silica may include a precipitated silica gel that is precipitated on the silicate substrate.

In some embodiments, the precipitated silica may form an adsorbent coating or layer that has been precipitated in-situ on the surface of the silicate substrate. As a result, while simple mixtures of filtration materials may segregate upon suspension (e.g., in fluid, conveyance, or transport), the composite silicate may retain both the adsorptive of the precipitated silica and the filtration properties of the silicate substrate. The in-situ precipitation of silica onto the silicate substrate may also provide advantages, such as increased adsorption and filtration properties, over other forms of composite filter aids, such as thermally sintered or chemically bonded composites. Without wishing to be bound by a particular theory, it is believed that the in-situ precipitation process may produce a filter aid composition having adsorbent components that are more evenly distributed on the substrate and, consequently, may exhibit a larger surface area for adsorption. The larger surface area may allow the composite silicate to adsorb a greater number of impurities and/or constituents which, in turn, may result in a lower turbidity level for the filtered fluid. Without wishing to be bound by a particular theory, it is believed that a substrate with a large surface area may avow for a reduction in the thickness of an adsorbent coating which may be formed thereon.

To prepare an exemplary composite silicate, a silicate substrate, such as, for example, diatomite, biogenic silica, or natural glass, can be mixed with water to form a free-flowing suspension. In some embodiments, the substrate can be the commercially-available filtration component Celite Standard Super Cele, manufactured by World Minerals, Inc. In some embodiments, the substrate can be a commercially-available filtration component selected from the group including Celite 3Z®, Celite 577®, Celite 289®, Celite 512®, Celite Filter-Cel®, and Celite Hyflo Super-Cel®, all manufactured by World Minerals, Inc.

A sodium silicate solution may then added to the substrate suspension, which raises the pH. The weight ratio of sodium silicate to the substrate may be, for example, about 1:3, but any ratio may be used. The sodium silicate may include to any one of several compounds that includes sodium oxide (Na₂O) and silica (SiO₂). Such combinations may include, for example, sodium ortho silicate (Na₄SiO₄), sodium meta silicate (Na₂SiO₃), and sodium disilicate (Na₂Si₂O₅). In some embodiments, the sodium silicate is a diatomite-based sodium silicate. Sodium silicate with a SiO₂/Na₂O ratio of about 3.2:1 and a concentration of 20% may be purchased, for example, from World Minerals Inc. Sodium silicate with a SiO₂/Na₂O ratio of about 3:1 and a concentration of 34.6% may be purchased, for example, from PQ Corp.

An acid, or a salt thereof, may then be added to the slurry in an amount sufficient to increase the acidity (i.e., reduce the pH) of the slurry to a pH range suitable for the precipitation of silica onto the surface of the substrate. Any suitable acid may be selected, such selection being within the know-how of one skilled in the art. In some embodiments, the acid may include one or more of sulfuric acid, phosphoric acid, hydrochloric acid, nitric acid, and/or acetic acid. The precipitated silicate may form a coating (e.g., layer) on the substrate's surface. According to some embodiments, the precipitated silica may include a silica gel. The precipitated silica may be an amorphous silica.

As the pH lowers, the slurry may be stirred periodically. According to some embodiments, the stirring may continue until gelling of the silica occurs, which may form a coating on the substrate. According to some embodiments, stirring may occur for about 25 to about 60 minutes, depending upon the acidity of the solution and the sodium silicate concentration in the slurry. The slurry may then be filtered and water may be added to the suspension to aid filtration. The resulting cake may be washed with water. The washed cake may then be dried until the excess fluid in the cake has evaporated. For example, the cake may be dried at a temperature ranging from about 110° C. to about 200° C. The resulting cake includes a silicate filtration component, such as, for example, diatomite, having a precipitated silica coating.

The amount of the sodium silicate used in the precipitation process may be chosen to control the pore size distribution in the composite silicate. For example, increasing the percentage of precipitated silica may increase the composite filter aid's ability to act as an adsorbent; however, it may also decrease its ability to act as a filter material. Conversely, decreasing the percentage of precipitated silica may decrease the composite filter aid's ability to act as an adsorbent, but may increase its ability to act as a filter material.

### Acid Treatment

According to some embodiments, the composite silicate may be treated with at least one acid. For example, the composite silicate may be treated with at least one mild acid, such as, for example, citric acid, acetic acid, oxalic acid, malic acid, tartaric acid, ascorbic acid, or mixtures thereof. The acid treatment may be performed by mixing the composite silicate with the acid or with a mixture of acid and water. According to some embodiments, the acid treatment may include spraying the acid or the mixture of acid and water onto the composite silicate. According to some embodiments, the mixture of composite silicate and acid, or composite silicate, acid, and water, may be mixed during or after the acid is added.

According to some embodiments, the acid-treated composite silicate may be dried after the acid treatment. Drying may occur in an oven and may be for one or more hours, or overnight. For example, the acid-treated composite silicate may be dried at a temperature greater than or equal to about 70° C., greater than or equal to about 80° C., greater than or equal to about 90° C., or greater than or equal to about 100° C. For example, the drying may occur in a range from about 70° C. to about 120° C., such as, for example, in a range from about 80° C. to about 110° C., from about 90° C. to about 110° C., from about 90° C. to about 100° C., or from about 100° C. to about 110° C.

According to some embodiments, the acid-treated filter aid may not be dried after acid treatment.

The amount of acid in the treatment may be greater than or equal to about 5% by weight relative to the total weight of the composite silicate and the acid combined, such as, for example, greater than or equal to about 7% by weight, greater than or equal to about 8% by weight, greater than or equal to about 9% by weight, greater than or equal to about 10% by weight, greater than or equal to about 11% by weight, greater than or equal to about 12% by weight, greater than or equal to about 13% by weight, greater than or equal to about 14% by weight, greater than or equal to about 15% by weight, greater than or equal to about 16% by weight, greater than or equal to about 17% by weight, greater than or equal to about 18% by weight, greater than or equal to about 19% by weight, or greater than or equal to about 20% by weight relative to the total weight of the acid and the composite silicate combined.

Where a mixture of water and acid is used to treat the composite silicate, the amount of acid in the treatment may be greater than or equal to about 5% by weight relative to the total weight of the silicate, the acid, and the water combined such as, for example, greater than or equal to about 7% by weight, greater than or equal to about 8% by weight, greater than or equal to about 9% by weight, greater than or equal to about 10% by weight, greater than or equal to about 11%, by weight, greater than or equal to about 12% by weight, greater than or equal to about 13% by weight, greater than or equal to about 14% by weight, greater than or equal to about 15% by weight, greater than or equal to about 16% by weight, greater than or equal to about 17% by weight, greater than or equal to about 18% by weight, greater than or equal to about 19% by weight, or greater than or equal to about 20% by weight relative to the total weight of the composite silicate, the acid, and the water combined. The amount of water acid in the treatment may be greater than or equal to about 5% by weight relative to the total weight of the composite silicate, the acid, and the water combined, such as, for example, greater than or equal to about 8% by weight, greater than or equal to about 10% by weight, greater than or equal to about 11% by weight, greater than or equal to about 12% by weight, greater than or equal to about 13%, by weight, greater than or equal to about 14% by weight, greater than or equal to about 15% by weight, greater than or equal to about 16% by weight, greater than or equal to about 17% by weight, greater than or equal to about 18% by weight, greater than or equal to about 19% by weight, greater than or equal to about 20% by weight, greater than or equal to about 22% by weight, or greater than or equal to about 24% by weight relative to the total weight of the composite silicate, the acid, and the water combined.

Without wishing to be bound by a particular theory, it is believed that the acid treatment reacts with a surface of the precipitated silica to improve the adsorption and/or impurity removal properties of the filter aid composition. According to some embodiments, the acid treatment may alter the surface chemistry of the composite silicate. For example, the acid treatment may lower the surface pH of the silica coating, which may facilitate adsorption of impurities, such as metals, soaps, and free fatty acids, from non-aqueous liquids. According to some embodiments, the acid-treated composite silicate may have a surface pH in a range from about 1 to about 5, such as, for example, from about 2 to about 5, from about 2 to about 3, from about 3 to about 4, or from about 4 to about 5.

Treating the composite silicate with a mild acid, such as citric acid, may also increase the flow rate and/or adsorption of impurities, such as soap, of the filter aid for filtering non-aqueous liquids, such as FAAEs, biodiesel, and oils (e.g., edible oils). Mixtures of acid and water to treat the composite silicates may be further used to specifically tailor the flow rate and adsorption properties of the acid-treated composite silicate. For example, such treatments may lower the wet density of the acid-treated composite silicate. Such treatments may also eliminate the need for a drying step, which may reduce production costs.

### Filter Aid Compositions

The acid-treated composite silicates may be used be used as part of a filter aid composition. For example, according to some embodiments, an acid-treated composite silicates may be used as a filter aid for filtering non-aqueous liquids, such as, for example, FAAEs, biodiesel, or edible oils. These filter aids may have a number of materials properties.

For example, “wet density” is an indicator of a material's porosity. For example, wet density reflects the void volume available to entrap particulate matter in a filtration process and, consequently, wet density may be used to determine filtration efficiency. Wet density also indicates the percent porosity of a material, which may be expressed by the following formula:

Porosity=100*[1−(wet density/true density)]

Thus, filtration components with lower wet densities may result in products with greater porosity, and thus perhaps greater filtration efficiency, provided that the true density stays relatively constant. According to some embodiments, the acid-treated composite silicates may have a wet density ranging from about 5 to about 30 lbs/ft³. Because wet density reflects the void volume of the adsorbent component to entertain matter in the filtration process, a lower wet density may indicate that the adsorbent component has a high void volume and thus can adsorb more particles and/or constituents in the fluid.

Adding water to the acid treatment may also improve the impurity removal (e.g., soap or metal removal) properties of the acid-treated composite silicate when filtering non-aqueous liquids, such as biodiesel or edible oils. Adding water to the acid treatment may also increase the filtration rate and/or permeability of the acid-treated composite silicate, thereby increasing the amount of non-aqueous liquid that can be filtered in a given time. Without wishing to be bound by a particular theory, citric acid is believed to benefit from water as a medium to interact with the soaps. By breaking down the soaps from long chains into shorter chains, which more effectively occurs in the aqueous phase, the soaps are less effective at blinding the filter, which improves flowrates and total throughput. Soap is the sodium salt of the fatty acid, and the proton from the citric acid is transferred to the soap to make a free fatty acid. The sodium is transported to the surface of the silica, and water is the transport medium for the ions to move.

According to some embodiments, the non-aqueous liquid may be an oil, such as an edible oil, animal oils, animal fats, hydrogenated oils, or combinations thereof. Suitable oils may include palm oil, palm kernel oil, cocoa butter, cocoa butter substitutes, illipe fat, shea fat, canola oil, castor oil, coconut oil, coriander oil, corn oil, cottonseed oil, hazelnut oil, hempseed oil, linseed oil, mango kernel oil, olive oil, peanut oil, rapeseed oil, rice bran oil, safflower oil, soybean oil, and sunflower oil, and mixtures thereof. The oil may have been subjected to one or more refining steps including degumming, bleaching, deodorizing and/or interesterification, such as, for example, by chemical or enzymatic treatment, prior to being filtered. According to some embodiments, the oil is preferably refined. The oil may additionally have undergone other treatment steps such as fractionation, prior to being filtered. According to some embodiments, the oil comprises one or more oils derived from palm. Oils derived from palm include palm oil, palm oil stearin, palm oil olein, palm kernel oil, palm kernel stearin and palm kernel olein, and interesterified products thereof. According to some embodiments, the vegetable oil comprises palm oil or a fraction thereof. Palm oil fractions include palm oil oleins, palm oil stearins, palm mid-fractions and interesterified products thereof. According to some embodiments, the vegetable oil may include refined palm oil or a fraction thereof, such as palm oil olein or palm oil stearin.

According to some embodiments, the acid-treated composite silicate may reduce the metal content of a non-aqueous liquid, such as, for example, by adsorption and/or filtration of metals or metal ions. Metals that may be adsorbed or filtered include, but are not limited to, sodium, calcium, potassium, iron, magnesium, phosphorus. In some embodiments, the acid-treated composite silicate may reduce the metal content by greater than or equal to about, for example, 90%, 85%, 80%, 75%, 70%, 65%, 60%, or 55%, or 50%. For example, as measured according to EN 14538, iron content may be reduced by greater than or equal to about 60%, 65%, 70%, 75%, 80%, 85%, or 90%. According to some embodiments, non-iron metal content may be reduced by greater than or equal to about, for example, 50%, 55%, 60%, 65%, 70%, 75%, or 80%. According to some embodiments, the amount of metal reduction may be affected by other parameters, such as, for example, the amount of metal present prior to filtration.

The acid-treated composite silicates described herein may also serve as replacement filter aids for diatomaceous earth, silica gel, or hydrogel filter aids. When compared with hydrogel filter aids, the acid-treated silicates may have acceptable filtration performance but may add less water to the FAAE liquid or biodiesel fluid as compared to a hydrogel. Without wishing to be bound by a particular theory, it is believed that the silicate substrate has a microporous stricture while precipitated silica has a nanoporous structure. This combination of microporosity and nanoporosity aids in filtering impurities of various size ranges, For example, the nanoporosity may aid in filtering metal and small molecule impurities, while the microporosity may aid in filtering large molecules such as soaps. The acid treatment of the composite silicates may also results in a change in the surface chemistry of the precipitated silica, making the precipitated silica more acidic. This increased acidity may facilitate adsorption of metals (e.g., metal ions), soaps and other impurities that would not be adsorbed or filtered without the increased acidity of the silica.

As used herein, “adsorption” is the tendency of molecules from an ambient fluid phase to adhere to the surface of a solid. This is not to be confused with the term “absorption,” which results when molecules from an ambient fluid diffuse into a solid, as opposed to adhering to the surface of the solid.

To achieve a desired adsorptive capacity, such as may be specified for commercial use, the acid-treated silicate may have a relatively large surface area, which may imply a fine porous structure. In certain embodiments, porous filter aids, in their un-reacted powder form, can have surface areas ranging up to several hundred m²/g.

As used herein, “surface area” refers to a BET surface area. “BET surface area,” as used herein, refers to the technique for calculating specific surface area of physical absorption molecules according to Brunauer, Emmett, and Teller (“BET”) theory. BET surface area can be measured with a Gemini III 2375 Surface Area Analyzer, using nitrogen as the sorbent gas, or ASAP® 2460 Surface Area and Porosimetry Analyzer, available from Micromeritics Instrument Corporation (Norcross, Ga., USA).

Filtration components with different BET surface areas and/or different total pore areas may result in different adsorption capacity and filtration rate. Typically, a filter aid with a lower BET and/or lower total pore area tends to have a lower adsorption capacity and a faster filtration rate. For example, calcined diatomaceous earth filter aids and expanded and milled perlite filter aids may serve as filter aids with higher flow rates, but with minimal adsorption function, because of the low surface area, which is typically less than 10 m²/g. Adsorbent components, such as silica gels, are generally high in BET surface areas or total pore areas, but their filtration rates are generally low, due to a much finer particle size distribution and/or the lack of porosity. The fine particles can block the pores during filtration, and the high surface area may create more drag on the flow, thus causing the filtration rate drop significantly. The acid-treated composite silicate described herein may provide both acceptable filtration rates and adsorption and impurity removal properties, as compared to untreated silicates (e.g., diatomaceous earth) or silica gels alone.

According to some embodiments, the acid-treated composite silicate may have a BET surface area in a range from about 5 to about 250 m²/g. For example, the acid-treated composite silicate may have a BET surface area in a range from about 5 to about 200 m²/g, from about 50 to about 250 m²/g, from about 100 to about 200 m²/g, from about 150 to about 250 m²/g, from about 10 to about 150 m²/g, from about 30 to about 150 m²/g, from about 30 to about 100 m²/g, from about 50 to about 100 m²/g, from about 50 to about 70 m²/g, from about 60 to about 80 m²/g, or from about 70 to about 90 m²/g.

One technique for describing pore size distributions in materials is mercury intrusion porosimetry, which uses mercury intrusion under applied isostatic pressure to measure micron-scale pores, such as those of the silicate substrate. In this method a material is surrounded by liquid mercury in a closed evacuated vessel and the pressure is gradually increased. The vessel is sealed and the pressure is reduced to a very low level before mercury intrusion begins. At low pressures, the mercury will not intrude into the powder sample due to the high surface tension of liquid mercury. As the pressure is increased, the mercury is forced into the sample, but will first intrude into the largest spaces, where the curvature of the mercury surface will be the lowest. As pressure is further increased, the mercury is forced to intrude into tighter spaces of the material. Eventually all the voids will be filled with mercury. Nano-porous structure was measured by nitrogen adsorption using an ASAP® 2460 Surface Area and Porosimetry Analyzer, available from Micromeritics Instrument Corporation (Norcross, Ga., USA). The plot of total void volume vs. pressure can thus be developed. The method can thus provide not only total pore volume, but also distinguish a distribution of pore sizes. Once a distribution of pores has been estimated, it is possible to calculate an estimation of surface area based on the pore sizes, and by assuming a pore shape (a spherical shape may be commonly assumed). Median pore size estimates can also be calculated based on volume or area. Median pore size (volume) is the pore size at 50^{th} percentile at the cumulative volume graph, while median pore size (area) is the 50^{th} percentile at the cumulative area graph. The average pore size (diameter) is four times the ratio of total pore volume to total pore area (4 V/A)

According to some embodiments, the silicate substrate may have a median pore diameter (4 V/A) in a range from about 0.1 to about 0.5 microns, such as, for example, in a range from about 0.1 to 0.4 microns, from about 0.1 to about 0.3 microns, from about 0.1 to about 0.2 microns, from about 0.2 to about 0.5 microns, from about 0.2 to about 0.4 microns, from about 0.2 to about 0.3 microns, from about 0.3 to about 0.5 microns, from about 0.3 to about 0.4 microns, or from about 0.4 to about 0.5 microns.

According to some embodiments, the silicate substrate may have a median pore diameter (volume) in a range from about 0.1 to about 10 microns, such as, for example, in a range from about 0.1 to about 5 microns, from about 0.5 to about 3 microns, from about 1 to about 5 microns, about 5 to about 10 microns, from about 2 to about 8 microns, or from about 3 to about 6 microns.

According to some embodiments, the silicate substrate may have a median pore diameter (area) in a range from about 1 to about 50 nm, such as, for example, in a range from about 1 to about 20 nm, from about 1 to about 10 nm, from about 1 to about 5 nm, from about 5 to about 10 nm, or from about 3 to about 8 nm.

According to some embodiments, the precipitated silica may have a pore size less than or equal to about 20 nm as measured by nitrogen adsorption using an ASAP® 2460 Surface Area and Porosimetry Analyzer. For example, the precipitated silica may have a pore size less than or equal to about 15 nm, such as, for example, less than or equal to about 10 nm, or less than or equal to about 5 nm. According to some embodiments, the precipitated silica may have a pore size in a range from about 5 nm to about 20 nm, such as, for example, from about 5 nm to about 15 nm, from about 5 nm to about 10 nm, or from about 10 nm to about 15 nm.

According to some embodiments, the precipitated silica may have a pore volume in a range from about 0.1 to about 0.5 cm³/g as measured as described above. For example, the precipitated silica may have a pore volume in a range from about 0.1 to about 0.3 cm³/g, or from about 0.3 to about 0.5 cm³/g.

According to some embodiments, the acid-treated composite silicate, may be processed to provide a wide range of flow rates, which are related to permeability. The filter aid compositions disclosed herein may have a permeability suitable for use in filtering non-aqueous liquids, such as, for example FAAEs, biodiesel, and edible oils. Permeability is generally measured in darcy units or darcies. Permeability may be determined using a device designed to form a filter cake on a septum from a suspension of filter aid composition in water, and then measuring the time required for a specified volume of water to flow through a measured thickness of filter cake of known cross-sectional area. For example, the permeability may be measured through a porous of filter aid material 1 cm high and with a 1 cm² section through which flows a fluid with a viscosity of 1 mPa·s with a flow rate of 1 cm³/sec under an applied pressure differential of 1 atmosphere. The principles for measuring permeability have been previously derived for porous media from Darcy's law (see, for example, J. Bear, “The Equation of Motion of a Homogeneous Fluid: Derivations of Darcy's Law,” in Dynamics of Fluids in Porous Media 161-177 (2nd ed. 1988)).

According to some embodiments, the acid-treated composite silicate may have a permeability in a range from 50 to 5000 md. For example, the acid-treated composite silicate may have a permeability in a range from about from about 50 to about 1000 md, from about 50 to about 500 md, from about 50 to about 300 md, from about 50 to about 200 md, from about 50 to about 100 md, from about 100 to about 400 md, from about 100 to about 300 md, from about 100 to about 200 md, from about 200 to about 300 md.

According to some embodiments, the precipitated silica may form a coating on the silicate substrate. The amount of precipitated silica may be in a range from about 5% to about 80% by weight of the composite silicate, such as, for example, from about 10% to about 50% by weight of the composite silicate.

The acid-treated composite silicate disclosed herein have a particle size. Particle size may be measured by any appropriate measurement technique now known to the skilled artisan or hereafter discovered. In one exemplary method, particle size and particle size properties, such as particle size distribution (“psd”), are measured using a Leeds and Northrup Microtrac X100 laser particle size analyzer (Leeds and Northrup, North Wales, Pa., USA). The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value. The d₁₀ value is the value at which 10% by weight of the particles have an esd less than that d₁₀ value. The d₉₀ value is the value at which 90% by weight of the particles have an esd less than that d₉₀ value.

According to some embodiments, the acid-treated composite silicate has a median particle size (d₅₀) in a range from 5 to 50 microns, such as, for example, from 5 to 40 microns, from 10 to 40 microns, from 10 to 30 microns, or from 15 to 25 microns.

The acid-treated composite silicate have a measurable wet density. According to one exemplary method, to measure wet density, a material sample of known weight from about 1.00 to about 2.00 g is placed in a calibrated 15 ml centrifuge tube. Deionized water is then added to make up a volume of approximately 10 ml. The mixture is shaken thoroughly until all of the sample is wetted, and no powder remains. Additional deionized water is added around the top of the centrifuge tube to rinse down any mixture adhering to the side of the tube from shaking. The tube is then centrifuged for 5 minutes at 2500 rpm on an IEC Centra® MP-4R centrifuge, equipped with a Model 221 swinging bucket rotor (International Equipment Company; Needham Heights, Mass., USA). Following centrifugation, the tube is carefully removed without disturbing the solids, and the level (i.e., volume) of the settled matter is measured in cm³. The centrifuged wet density of powder can be calculated by dividing the sample weight by the measured volume. According to some embodiments, the acid-treated composite silicates may have a wet density in a range from 5 to 30 lbs/ft³. For example, the acid-treated composite silicates may have a wet density in a range from about 5 to about 25 lbs/ft, from about 5 to about 20 lbs/ft³, from about 5 to about 15 lbs/ft³ from about 5 to about 10 lbs/ft³, from about 10 to about 25 lbs/ft³, from about 10 to about 20 lbs/ft³, from about 10 to about 15 lbs/ft³, from about 15 to about 30 lbs/ft³, from about 15 to about 20 lbs/ft³, or from about 20 to about 30 lbs/ft³.

### Exemplary Uses for Filter Aids

The exemplary filter aids, such as the acid-treated composite silicate, disclosed herein may be used in any of a variety of processes, applications, and materials, such as, for example, filtering FAAEs, such as biodiesel. Although biodiesel is described as an exemplary liquid, it is understood that other non-aqueous liquids could also be filtered. For example, the filter aids may also be used to filter oils, such as edible oils.

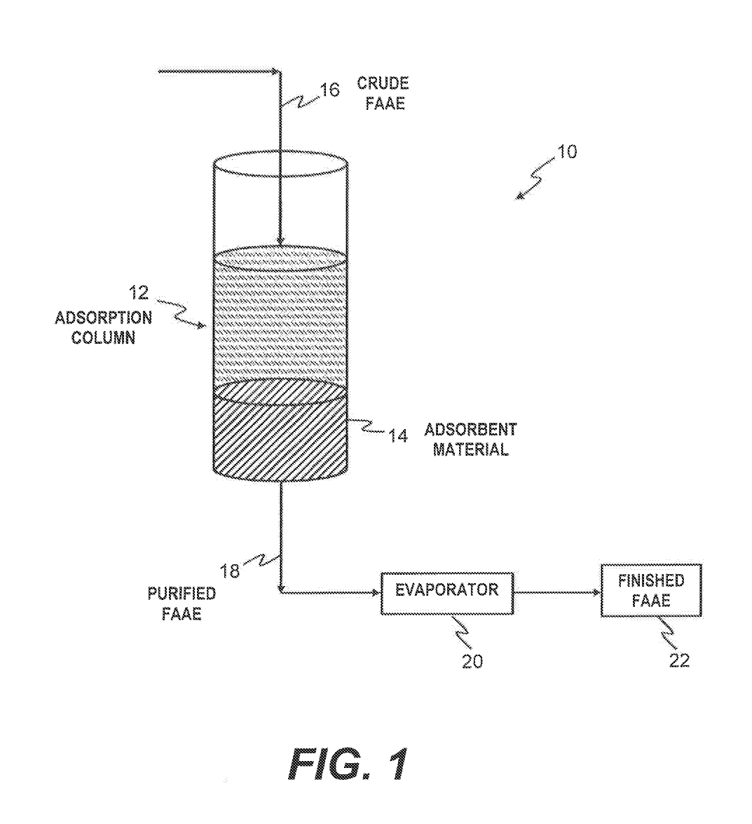

FIG. 1 shows an exemplary process flow for filtering FAAEs, FIG. 1 is a schematic diagram of biodiesel purification by a filtration system. Filtration system 10, includes an adsorption column 12 having an adsorbent material 14. Adsorbent material 14 includes an acid-treated composite silicate to purify biodiesel 16. Biodiesel 16 may be a crude or previously filtered biodiesel. Although FIG. 1 shows only a single adsorption column 12, it is understood that two or more adsorbent columns may be placed in series and/or in parallel to increase the filtration rate of filtration system 10 and/or increase the purification of the filtered biodiesel. Crude biodiesel 16 may include a crude feed of fatty acid alkyl esters (FAAEs) or oils, which is contacted with a sufficient amount of adsorbent material 14 to remove impurities, such as, for example, soaps, catalysts, metals, free glycerin, sterol glycosides, and other impurities that reduce the stability of biodiesel. Suitable adsorbent materials 14 include the filter aids described herein (e.g., acid-treated silicates, acid-treated composite silicates, and mixtures thereof, which may further include additional filter aid materials). After passing through adsorbent material 14, the biodiesel is considered filtered biodiesel 18.

Purified biodiesel 18 exits adsorption column 12 and may optionally pass to an evaporator 20. Evaporator 20 may be used to recover alcohol components of purified biodiesel 18, such as methanol. According to some embodiments, evaporator 20 is a flash evaporator. After passing through evaporator 20, the biodiesel may undergo further processing to create a biodiesel product 22.

As biodiesel 16 passes through adsorbent material 14, impurity deposits may accumulate on adsorbent material 14, reducing the flow rate and filtration efficiency of adsorbent material 14. These combined layers of impurity and filter aid are sometimes referred to as a “filter cake.” As more and more particles and/or impurities are deposited on the filter cake, the filter cake may become saturated with debris to the point where fluid is no longer able to pass through at an acceptable rate. To help alleviate this problem, additional filter aid material may be introduced by “body feeding.” Body feeding is the process of introducing additional filter aid material into the fluid to be filtered before the fluid reaches the filter cake, such as before biodiesel 16 contacts adsorbent material 14. The filter aid material follows the path of the unfiltered fluid and, upon reaching adsorbent material 14, the added filter-aid material will bind to or settle on the filter cake. These additional layers of filter aid material cause the filter cake to swell and thicken and increases the capacity of the cake to entrap additional debris and impurities. Body feeding may also help the filter aid maintain an open structure in the filter cake, which may help to maintain permeability and flow rate of the filter cake.

The exemplary acid-treated composite silicates may be used in a variety of filtration processes and compositions. According to some embodiments, a filter element may be used to support the composite silicate. In some embodiments, the filter element contains filter element voids through which fluid may flow. In some embodiments, the acid-treated composite silicates may be applied to a filter septum to protect it and/or to improve clarity of the liquid to be filtered in a filtration process. In some embodiments, the acid-treated composite silicate may added directly to the fluid, such as a non-aqueous fluid (e.g., biodiesel or edible oils) to be filtered to increase flow rate and/or extend the filtration cycle. In some embodiments, the acid-treated composite silicates may be used as pre-coating layer for a filter element, in body feeding to help improve the usable life of a filter cake and/or to maintain flow properties through the filter, or a combination of both pre-coating and body feeding, in a filtration process.

In some embodiments, the acid treated composite silicate may be produced by adding the composite silicate and an acid to the fluid to be filtered. For example, a composite filter aid including diatomite and precipitated silica, and a desired amount of aqueous citric acid may be added to the fluid as a body feed, and then filtered through a precoat filter. In some embodiments, the fluid to be filtered may be a hydrophobic fluid, such as, for example, an edible oil or biodiesel.

Embodiments of the acid-treated composite silicates may also be used in a variety of filtering methods. In some embodiments, the filtering method includes pre-coating at least one filter element with the composition material, and contacting at least one liquid to be filtered with the at least one coated filter element. In such embodiments, the contacting may include passing the liquid through the filter element. In some embodiments, the filtering method includes suspending the filter aid composition the liquid to be filtered, and thereafter separating the filter aid composition from the filtered liquid.

Although certain embodiments may be described with reference to the acid-treated composite silicate, it is understood that these are exemplary only and that the acid-treated composite silicate may additionally be combined with other filter aid materials, such as, for example, non-acid-treated silicates (e.g., diatomaceous earth) or natural glasses, silica gels, or hydrogels.

### EXAMPLES

Several examples consistent with the filter aid compositions disclosed herein are described below. A control composition of synthetic amorphous hydrated silica was obtained, which is commercially available as SORBSIL® R92 from PQ Corporation of Joliet, Ill. A comparative example of synthetic magnesium silicate, commercially available as CELITE® CELKATE® T21 from World Minerals Inc. of San Jose, Calif., was also provided. Examples A-G were prepared by mixing a precipitated-silica coated diatomite, commercially available as CELITE® CYNERGY® from Imerys Minerals of Lompoc, Calif., with varying weight percent of water and citric acid (greater than 99% pure anhydrous citric acid). To prepare each example, the precipitated-silica coated diatomite was placed in a KITCHEN AID® brand mixer and sprayed with the citric acid-water mixture and stirred for 30 minutes. The compositions of the control sample, comparative sample, and Examples A-G are shown below in Table 1

Biodiesel fuel was filtered through each of the control and comparative samples and Examples. The biodiesel was the bottom fraction of a biodiesel distillation column. A 55 mm Whatman #4 filter paper and Buchner funnel were used for filtration. 4 g of DE (Kenite 1000®) was mixed with about 20 g biodiesel at 80° C. This was precoated onto the filter by vacuum, and the filtrate was discarded. 666 g of test material was added to 100 mL of biodiesel also at 80° C. After 10 minutes of contact time, the treated biodiesel was filtered through the precoated filter. The time for filtration was recorded, and the resulting filtered biodiesel was collected for soap content, which was determined via a standard ASTM method for soap determination in oil. In addition, the soap content of the unfiltered biodiesel was measured. The filtration rate was determined based on the amount of biodiesel filtered through the filter aid. The test results, including the soap content remaining in the biodiesel in ppm, are shown below in Table 1.

TABLE 1

| | | Filtration | | |
|---|---|---|---|---|
| | Soap | Rate | Moisture | Citric Acid |
| | ppm | mL/min | % wt | % wt |
| SG Control | 658 | 6.3 | 52 | 3-7 |
| | 556 | 2.9 | 0.9 | 5.2 |
| | 406 | 1.1 | 0.9 | <1 |
| | 724 | 3.6 | 1.5 | 6.5 |
| | 490 | 1.1 | 1 | <1 |
| | 262 | 0.8 | 1.5 | 0 |
| SG Control | 196 | 7.7 | 52 | 3-7 |
| | 519 | 1.9 | 0.5 | 5.2 |
| | 829 | 6.3 | 3.1 | 6.5 |
| SG Control | 763 | 6.3 | 52 | 3-7 |
| | 1172 | 6.7 | 16.6 | 5.6 |
| | 1369 | 15.4 | 25.4 | 7.1 |
| | 258 | 13.3 | 13.4 | 12.5 |
| | 1003 | 9.1 | 13.6 | 15 |
| | 1495 | 16.7 | 11 | 12.1 |
| | 1087 | 13.3 | 11 | 15 |
| | 1147 | 11.8 | 8.4 | 11.6 |

As shown in Table 1, it is clear that, relative to untreated Cynergy® (low water, no citric acid), treating the filter aid composites with just citric acid (Le., without water) improves filtration rate, and further, treating the composite filter aid with citric acid and water improves filtration rate even more. These results also show that there is a fairly linear relationship between filtration rate and soap removal. The faster filtration rate removes less soaps.

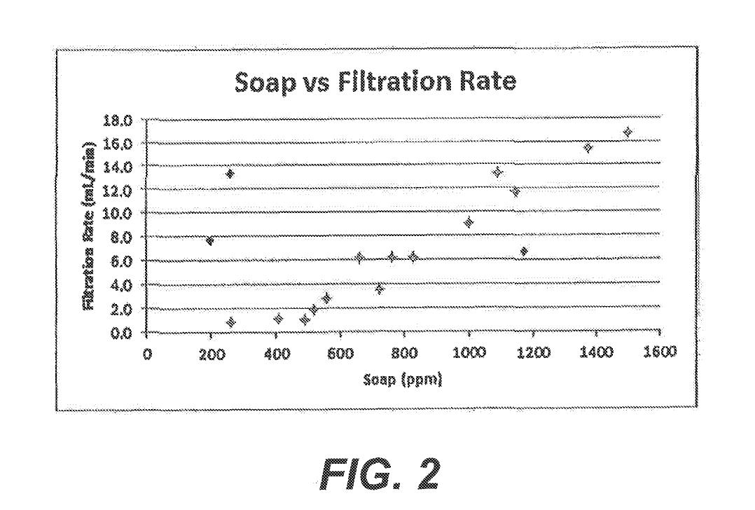

Further experiments were performed to attempt to correlate soap removal with filtration rate using Examples and three control examples. The results are shown in Table 1 and FIG. 2. The data points show a strong correlation between filtration rate and soap adsorption (R²=0.95), with soap adsorption (e.g., removal) decreasing with increasing filtration rate.

The results in Table 1 indicate that the acid-treated silicate materials of the Examples may have improved impurity removal properties, such as, for example, improved soap removal properties, from FAAEs, biodiesels, and edible oils. It was also observed that adding water to the sample increased the filtration rate of the biodiesel. The filtration rates and soap removal properties indicate that the acid-treated precipitated-silica coated diatomite may be used as a replacement for diatomite and/or hydrogel filter aids in filtering non-aqueous liquids, such as FAAEs, biodiesel or edible oils.

A further experiment was performed to determine the effectiveness of an acid-treated composite filter aid in removing metal from biodiesel. For this experiment, trial runs were carried out with an exemplary acid-treated composite filter aid and biodiesel. The sample biodiesel, prior to being filtered, included, on average 5.7 ppm calcium, 19.6 ppm magnesium, 1.3 ppm potassium, 3.0 ppm iron, 250 ppm sodium, and 33.97 ppm phosphorus.

Although the amount of calcium remained virtually the same with the filter aid consistent with the inventive filter aid, the level of calcium following filtration increased with the hydrogel control. Other metals were also reduced by the filtration using the filter aid consistent with the inventive filter aid. For example, beginning with 5.7 ppm magnesium, the average amount of magnesium removed was about 61.4% relative to the beginning amount. Beginning with 1.3 ppm potassium, the average amount of potassium removed was about 53.8% relative to the beginning amount. Beginning with 3.0 ppm iron, the average amount of iron removed was about 79.2% relative to the beginning amount. Beginning with 250 ppm sodium, the average amount of sodium removed was about 58.5% relative to the beginning amount. Beginning with 33.97 ppm phosphorus, the average amount of phosphorus removed was about 58.3% relative to the beginning amount. This shows that the exemplary acid-treated composite filter aid was effective, except for calcium, in removing significant amounts of metals from the biodiesel sample.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-36. (canceled)

37. A method for filtering a non-aqueous liquid, the method comprising:
providing a non-aqueous liquid for filtering; and
filtering the non-aqueous liquid through an acid-treated composite silicate,
wherein the composite silicate comprises a silicate substrate and a precipitated silica.

38. The method of claim 37, further comprising, prior to filtering the non-aqueous liquid, pre-coating a filter structure with the acid-treated composite silicate.

39. The method of claim 37, wherein providing the non-aqueous liquid comprises adding the acid-treated composite silicate as a body feed in the non-aqueous liquid.

40. The method of claim 37, wherein the acid-treated composite silicate has a wet density in a range from about 10 to about 25 lbs/ft³.

41. The method of claim 37, wherein the non-aqueous liquid comprises a biodiesel.

42. The method of claim 37, wherein the non-aqueous liquid comprises an edible oil.

43. The method of claim 37, wherein the acid-treated composite silicate has a wet density in a range from about 5 to about 30 lbs/ft³.

44. The method of claim 37, wherein the acid-treated composite silicate has a permeability in a range from about 50 to about 1000 md.

45. (canceled)

46. A method for filtering a non-aqueous liquid, the method comprising:
providing a non-aqueous liquid for filtering;
admixing a composite silicate and an acid with the non-aqueous liquid as a body feed; and
filtering the non-aqueous liquid through a filter structure to separate the composite silicate from the non-aqueous liquid,
wherein the composite silicate comprises a silicate substrate and a precipitated silica.

47. The method of claim 46, further comprising, prior to filtering the non-aqueous liquid, pre-coating the filter structure with the composite silicate.

48. The method of claim 46, wherein the composite silicate has a wet density in a range from about 5 to about 30 lbs/ft³.

49. The method of claim 46, wherein the acid-treated composite silicate has a permeability in a range from about 50 to about 1000 md.
